(19) United States
(12) Patent Application Publication
(10) Pub. No.: US 2011/0316783 A1
(43) Pub. Date: Dec. 29, 2011

(54) INFORMATION PROCESSING APPARATUS, METHOD, AND RECORDING MEDIUM

(75) Inventor: Masatoshi KIMURA, Kawasaki (JP)

(73) Assignee: FUJITSU LIMITED, Kawasaki-shi (JP)

(21) Appl. No.: 13/112,305

(22) Filed: May 20, 2011

(30) Foreign Application Priority Data
Jun. 28, 2010 (JP) 2010-146692

(51) Int. Cl. G09G 5/00; G06F 3/033; G06F 3/041

(52) U.S. Cl. 345/167; 345/1.1; 345/173

(57) ABSTRACT

An information processing apparatus includes, a screen switching input unit to input an instruction for switching between a screen displayed on a first display unit and a screen displayed on a second display unit, and a display control unit to display, in response to input of the switching instruction, the screen displayed on the first display unit on the second display unit and disabling displaying of the screen displayed on the second display unit before input of the switching instruction on the first display unit.

### CROSS-REFERENCE TO RELATED APPLICATIONS

This application is related to and claims priority to Japanese Patent Application No. 2010-146692, filed on Jun. 28, 2010, and incorporated herein by reference.

### FIELD

The present invention relates to an information processing apparatus, method, and recording medium.

### BACKGROUND

Recently, the number of media distributing various movies, such as a movie site on the Internet, has been increasing. Additionally, there is an increasing demand for viewing movies downloaded onto personal computers (PCs) on media with large screens such as televisions (TVs). Thus, opportunities for displaying operation screens of the PCs on TVs having large display screens are also increasing.

When users want to view videos, such as programs sent from broadcasting stations, these videos are displayed on the TVs that may be utilized as the operation screens of the PCs in this way. Since the TVs are not utilized as the operation screens of the PCs in such a case, the operation screens of the PCs have to be displayed on an auxiliary screen, such as a small monitor, to operate the PCs. Additionally, when users retrieve a movie and then show the movie to their family, the retrieval operation is not necessarily shown to all of the family. Thus, the users perform the retrieval with the auxiliary screen and then display only the movie on the TVs after finding an intended movie. When the PCs are connected to the TVs and the TVs are set to display the operation screens of the PCs thereon, the TVs connected to the PCs and the auxiliary screen are often switched between for use. Hereinafter, a screen used as a main screen for performing operations of the PCs is referred to as a primary display, whereas a screen used as a sub screen for performing the operations of the PCs is referred to as a secondary display.

A technique is provided that displays, on an auxiliary screen, a window that is hidden when an active window is displayed in full-screen on the primary display (Japanese Unexamined Patent Application Publication No. 2002-175173). Additionally, a technique is provided that moves, in response to a specified operation performed with a plurality of windows being displayed on one display, the screens other than the one needed to another display (Japanese Unexamined Patent Application Publication No. 04-015688).

### SUMMARY

According to an aspect of the invention, an information processing apparatus includes a screen switching input unit to input an instruction to switch between a screen displayed on a first display unit and a screen displayed on a second display unit, and a display control unit to display, in response to the switching instruction, the screen displayed on the first display unit on the second display unit and disabling displaying of the screen displayed on the second display unit before input of the switching instruction on the first display unit.

The object and advantages of the invention will be realized and attained by at least the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a schematic diagram illustrating a configuration of a system including an information processing apparatus.

FIG. 2 is a block diagram of a system including an information processing apparatus according to a first embodiment.

FIG. 3 is a diagram of a hardware configuration of a wireless device according to the first embodiment.

FIG. 4 is a plan view illustrating a state in which a touch-panel screen is displayed on a display unit of the wireless device.

FIG. 5 is a diagram of a transition of a screen resulting from screen switching.

FIG. 6 is a diagram of a hardware configuration of a main body according to the first embodiment.

FIG. 7 is a flowchart of screen switching processing from a first or third state to a second or fourth state in the information processing apparatus according to the first embodiment.

FIG. 8 is a flowchart of processing to switch between a primary display and a secondary display.

FIG. 9 is a flowchart of screen switching processing from the second or fourth state to the first or third state in the information processing apparatus according to the first embodiment.

FIG. 10 is a block diagram of a system including an information processing apparatus according to a second embodiment.

FIG. 11 is a diagram of a hardware configuration of a wireless device according to the second embodiment.

FIG. 12 is a diagram of an example of a screen displaying a message saying that utilization of a home button is disabled.

FIG. 13 is a flowchart of processing performed in response to pressing of a home button.

### DESCRIPTION OF THE EMBODIMENTS

Embodiments of an information processing apparatus, a method of controlling the information processing apparatus, and a recording medium storing a program for controlling the information processing apparatus disclosed in this application will be described in detail below based on the accompanying drawings. However, it should be noted that the information processing apparatus, the method of controlling the information processing apparatus, and the recording medium storing the program for controlling the information processing apparatus disclosed in this application are not limited by the following embodiments.

### First Embodiment

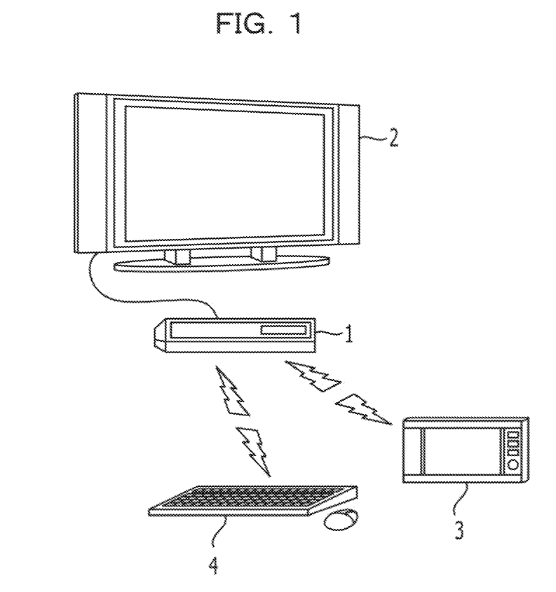

FIG. 1 is a schematic diagram illustrating a configuration of a system including an information processing apparatus. As illustrated in FIG. 1, the system including the information processing apparatus according to this embodiment includes a main body 1 formed by a casing including a central processing unit (CPU), a memory, and a hard disk, a television (TV) 2, a wireless device 3, and a wireless keyboard/mouse 4. Here, the main body 1 serves as an example of the information processing apparatus. In this embodiment, a description will be given based on an assumption that a personal computer (PC) serves as the information processing apparatus.

The main body 1 is connected to the TV 2 with a cable. The main body 1 is also wirelessly connected to the wireless device 3 and the wireless keyboard/mouse 4. The main body 1 wirelessly exchanges data with the wireless device 3 and the wireless keyboard/mouse 4.

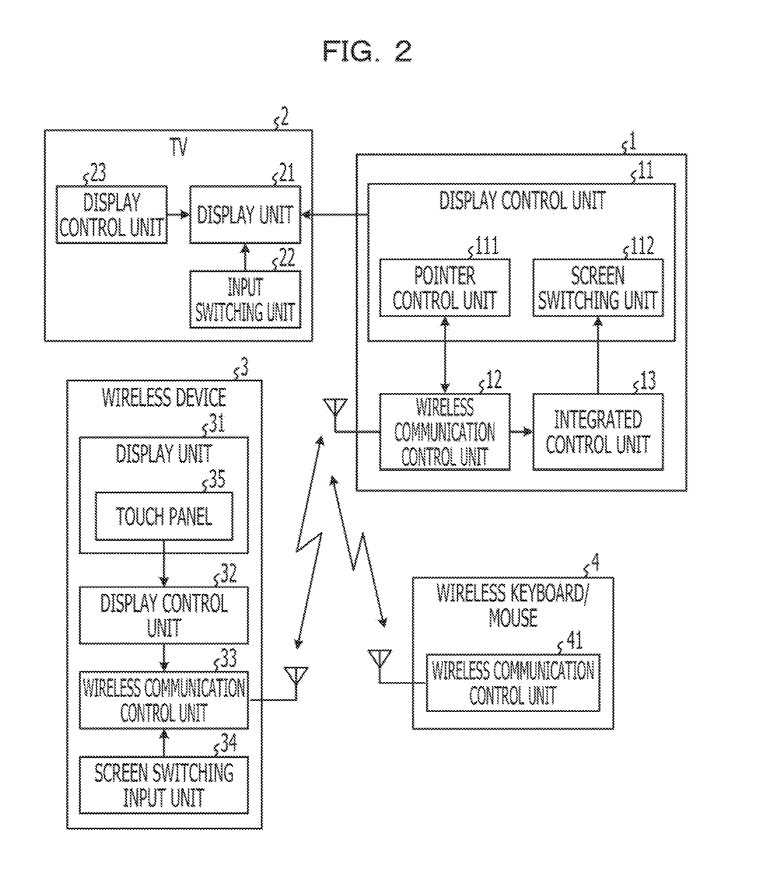

Details of the system including the information processing apparatus according to the embodiment will now be described with reference to FIG. 2. FIG. 2 is a block diagram of the system including the information processing apparatus according to the first embodiment.

A description will be first given for the TV 2. As illustrated in FIG. 2, the TV 2 includes a display unit 21, an input switching unit 22, and a display control unit 23. In this embodiment, the TV 2 includes a high-definition multimedia interface (HDMI) terminal (not illustrated). The TV 2 is connected to the main body 1 via the HDMI. Furthermore, in this embodiment, the TV 2 may be controlled with a HDMI-CEC (consumer electronics control). Since the TV 2 may be controlled with a HDMI-CEC, the TV 2 may receive control operations, such as power-on/off and input switching, from the main body 1. Additionally, because the TV 2 may be controlled with a HDMI-CEC, the main body 1 may grasp a source of an image signal that the TV 2 uses to display images on the display unit 21. Although using a HDMI for connection between the TV 2 and the main body 1 has been described in this embodiment, a digital visual interface (DVI) may be used. Furthermore, the TV 2 exchanges a HotPlugDetect signal with the main body 1. The Hot Plug Detect signal is for determining whether a cable to the TV 2 is connected.

The display unit 21 may be, for example, a liquid crystal screen. The display unit 21 also includes a plurality of input paths for receiving video signals to be displayed. In this embodiment, one of the input paths is assigned to input from the main body 1. When the input of the display unit 21 is set to the input from the main body 1, the display unit 21 may display an image of software activated in the main body 1. The software displayed in the main body 1 may be, for example, document editor software and spreadsheet software. Additionally, in this embodiment, one of the remaining input paths is assigned to input a TV video. Here, the TV video indicates a video distributed from a broadcasting station. That is, when the TV video is displayed on the display unit 21, the TV 2 is used to view the TV program. Hereinafter, changing the input path of the display unit 21 may be referred to as changing input of the display unit 21. The display unit 21 serves as an example of a first display unit.

An operator specifies a device for inputting a signal to the display unit 21 using an input switching button (not illustrated) of the TV 2. Here, the inputting device is, for example, the main body 1 or the display control unit 23 of the TV 2 described below. Upon receiving the specification of the device for inputting the signal to the display unit 21 from the operator, the input switching unit 22 switches the input of the display unit 21. For example, when the operator specifies a TV video supplied from the display control unit 23, the input switching unit 22 switches the input of the display unit 21 to the input from the display control unit 23. Additionally, when the operator specifies input of an operation screen of a personal computer (PC) supplied from the main body 1, the input switching unit 22 switches the input of the display unit 21 to the input from a display control unit 11 of the main body 1.

The display control unit 23 causes the display unit 21 to display a TV video received from a broadcasting station or the like.

The wireless device 3 will now be described. The wireless device 3 includes a display unit 31, a display control unit 32, a wireless communication control unit 33, and a screen switching input unit 34.

The wireless communication control unit 33 wirelessly communicates with a wireless communication control unit 12 of the main body 1. In this embodiment, the wireless communication control unit 33 performs communication using a wireless universal serial bus (USB). Signals are exchanged between each unit of the wireless device 3 and the corresponding unit of the main body 1 through the wireless communication control unit 33. However, for ease of explanation, a description will be given below as if signals were directly exchanged between each unit of the wireless device 3 and the corresponding unit of the main body 1.

The display unit 31 may be a liquid crystal display (LCD). The display unit 31 also includes a touch panel 35. The touch panel 35 detects a touch operation with a finger of a user or a touch pen. An operator may perform an input operation using the touch panel 35. The display unit 31 displays a touch-panel screen for an operation though the touch panel 35 or a PC operation screen other than the touch-panel screen. Hereinafter, the PC operation screen other than the touch-panel screen is simply referred to as a “PC operation screen”. When the PC operation screen is displayed on the display unit 31, the operator may move a pointer using the touch panel 35. The display unit 31 serves as an example of a second display unit.

The display control unit 32 receives data from the display control unit 11 of the main body 1. The display control unit 32 then performs image conversion, such as positioning of the received data for the display unit 31. The display control unit 32 displays the PC operation screen on the display unit 31. The display control unit 32 also outputs input supplied from the touch panel 35 to the display control unit 11 and an integrated control unit 13 of the main body 1.

The screen switching input unit 34 includes a button for inputting a screen switching instruction. The operator presses the button of the screen switching input unit 34, whereby the screen switching instruction is sent to the display control unit 11 and the integrated control unit 13 of the main body 1.

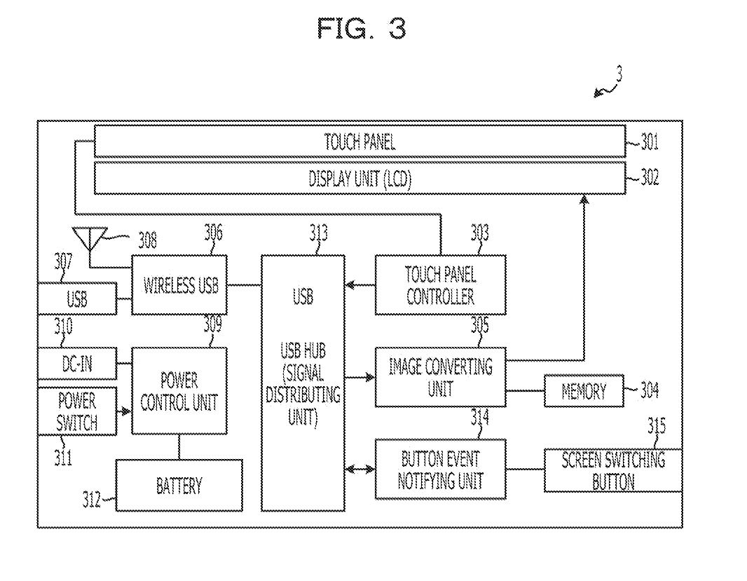

A hardware configuration of the wireless device 3 will now be described with reference to FIG. 3. FIG. 3 is a diagram of a hardware configuration of the wireless device 3 according to the first embodiment. The wireless device 3 includes a display unit 302, such as a liquid crystal display (LCD). This display unit 302 has a function of the display unit 31 in FIG. 2. The display unit 302 includes a touch panel 301. This touch panel 301 has a substantially similar function of the touch panel 35 in FIG. 2. The touch panel 301 is connected to a touch panel controller 303. The touch panel controller 303 controls input from the touch panel 301. Additionally, the display unit 302 is connected to an image converting unit 305. The image converting unit 305 is further connected to a memory 304. The image converting unit 305 converts an image sent from the main body 1 before the converted image is displayed on the display unit 302. At this time, the image converting unit 305 temporarily stores the image in the memory 304 as needed. A combination of the touch panel controller 303, the memory 304, and the image converting unit 305 has a substantially similar function of the display control unit 32 in FIG. 2. The display control unit 32 causes the display unit 302 to display received data under control of a CPU. A USB terminal 307 is for connecting the wireless device 3 to the main body 1 with a USB cable. A wireless USB 306 wirelessly communicates with the main body 1 through an antenna 308. This wireless USB 306 has a function of the wireless communication control unit 33 in FIG. 2. A screen switching button 315 is connected to a button event notifying unit 314. If the operator presses the screen switching button 315, the button event notifying unit 314 determines that a screen switching instruction is input and then outputs the screen switching instruction to the main body 1. The screen switching button 315 and the button event notifying unit 314 have a function of the screen switching input unit 34 in FIG. 2. A USB hub 313 outputs the input from the touch panel controller 303 to the main body 1. The USB hub 313 also outputs an image signal supplied from the main body 1 to the image converting unit 305. The USB hub 313 further outputs the screen switching instruction supplied from the button event notifying unit 314 to the main body 1. A battery 312 supplies power to each unit of the wireless device 3. A power switch 311 is for turning on/off the wireless device 3. A power control unit 309 controls power supply from the battery 312 in response to power-on/off through the power switch 311. Additionally, a DC-IN 310 is an input terminal for receiving power from outside.

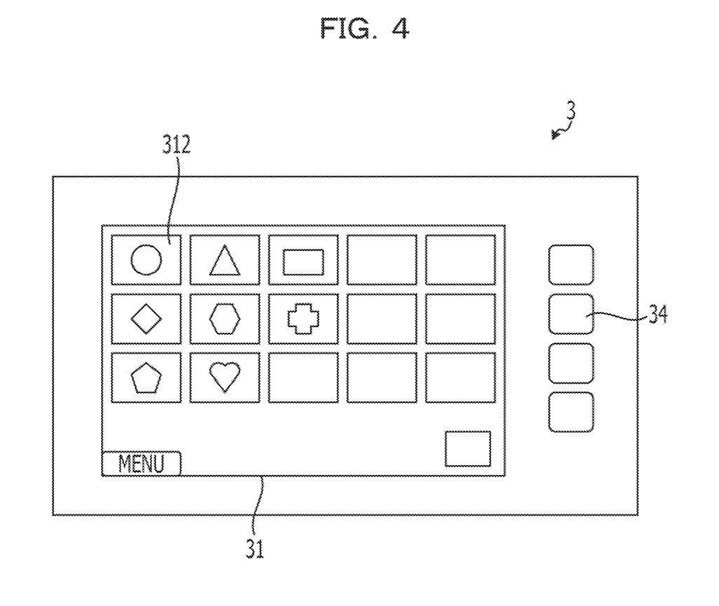

An appearance of the wireless device 3 and an example of the touch-panel screen will now be described with reference to FIG. 4. FIG. 4 is a plan view representing a state in which the touch-panel screen is displayed on the display unit 31 of the wireless device 3. In this embodiment, an application launcher for managing activation of an application is used as the touch-panel screen.

The display unit 31 includes the touch panel 35. Referring to FIG. 4, the touch-panel screen is displayed on the display unit 31. The display unit 31 displays the application launcher. A FIG. 312 that is arranged on the application launcher displayed on the display unit 31 and is enclosed by a small rectangle indicates an application activation button. The operator physically presses the FIG. 312 with their hand, thereby inputting an application activation instruction for the FIG. 312. Furthermore, as illustrated in FIG. 4, a screen switching input unit 34 is provided separately from the display unit 31.

The wireless keyboard/mouse 4 will now be described. The wireless keyboard/mouse 4 includes a wireless communication control unit 41 as well as a keyboard and a mouse.

The wireless communication control unit 41 wirelessly communicates with the wireless communication control unit 12 of the main body 1. In this embodiment, the wireless communication control unit 41 performs communication using a wireless USB.

The wireless keyboard/mouse 4 outputs information input through the keyboard or the mouse to the display control unit 11 or the integrated control unit 13 of the main body 1 through the wireless communication control unit 41.

The main body 1 of the PC will now be described. As illustrated in FIG. 2, the main body 1 includes the display control unit 11, the wireless communication control unit 12, and the integrated control unit 13.

The wireless communication control unit 12 wirelessly transmits and receives data to and from the wireless device 3 and the wireless keyboard/mouse 4. More specifically, the wireless communication control unit 12 receives a wireless signal from the wireless device 3 and the wireless keyboard/mouse 4 and then outputs the wireless signal to the display control unit 11 and the integrated control unit 13. The wireless communication control unit 12 also wirelessly outputs a signal supplied from the display control unit 11 and the integrated control unit 13 to the wireless device 3 and the wireless keyboard/mouse 4. Although signals are actually exchanged between each unit of the main body 1 and the corresponding unit of the wireless device 3 and the wireless keyboard/mouse 4 through the wireless communication control unit 12 in this way, a description will be given as if signals were directly exchanged between each unit of the corresponding unit of the main body 1 and each unit of the wireless device 3 and the wireless keyboard/mouse 4, for ease of explanation.

The display control unit 11 includes a pointer control unit 111 and a screen switching unit 112. The display control unit 11 also prestores a format of the touch-panel screen.

The screen switching unit 112 receives, from the integrated control unit 13 described below, information regarding whether the TV 2 is connected via the HDMI and information regarding whether HDMI-CEC setting is enabled. When the HDMI-CEC setting is enabled for the TV 2, the screen switching unit 112 determines whether the TV 2 is turned on and the input of the display unit 21 is set to input from the main body 1 upon receiving the screen switching instruction from the wireless device 3. Here, in this embodiment, the input state of the display unit 21 may be acquired from the integrated control unit 13 to be described later. If the TV 2 is off, the screen switching unit 112 turns on the TV 2. Additionally, if the input of the display unit 21 is not set to the input from the main body 1, the screen switching unit 112 changes the input of the display unit 21 to the input from the main body 1. In this way, the screen switching unit 112 may construct a multi-display environment allowing the main body 1 to utilize a plurality of screens.

When the TV 2 is turned on and the input of the display unit 21 is set to the input from the main body 1, the screen switching unit 112 switches between setting of the primary display and the secondary display. More specifically, when the display unit 21 and the display unit 31 are set as the primary display and the secondary display, respectively, the screen switching unit 112 sets the display unit 31 as the primary display and the display unit 21 as the secondary display. Furthermore, the screen switching unit 112 switches between a screen displayed on the display unit 21 of the TV 2 and a screen displayed on the display unit 31 of the wireless device 3. More specifically, the screen switching unit 112 displays, on the display unit 31, the screen displayed on the display unit 21. The screen switching unit 112 further determines whether the screen displayed on the display unit 31 is the touch-panel screen. If the screen displayed on the display unit 31 is not the touch-panel screen, the screen switching unit 112 displays, on the display unit 21, the screen having been displayed on the display unit 31. In contrast, if the screen displayed on the display unit 31 is the touch-panel screen, the screen switching unit 112 disables displaying of the touch-panel screen on the display unit 21. The screen switching unit 112 then displays the PC operation screen on the display unit 21.

A reason why the screen switching unit 112 disables displaying of the touch-panel screen on the display unit 21 will now be described. The display unit 21 does not include a touch panel. Additionally, the operator is unable to perform an input operation using a pointer on the touch-panel screen. When the touch-panel screen having been displayed on the display unit 31 is displayed on the display unit 21, the operator is unable to perform an operation using the screen displayed on the display unit 21. Accordingly, when the touch-panel screen is displayed on the display unit 31, the screen switching unit 112 disables displaying of the screen having been displayed on the display unit 31 on the display unit 21 in response to the screen switching instruction to avoid a circumstance where the operator is unable to perform the operation using the screen of the display unit 21.

On the other hand, when the screen switching instruction for changing the display unit 31 to the secondary display is input with the HDMI-CEC setting being disabled in the TV 2, the screen switching unit 112 displays on the display unit 31 information saying that switching is not permitted. Additionally, when the screen switching instruction for changing the display unit 31 to the primary display is input with the HDMI-CEC setting being disabled in the TV 2, the screen switching unit 112 changes the display unit 31 to the primary display and just displays the PC operation screen on the display unit 31. Conversely, when the screen switching instruction for changing the display unit 31 to the secondary display with the HDMI-CEC setting being disabled for the TV 2, the screen switching unit 112 displays on the display unit 31 information saying that switching is not permitted.

In response to input from the wireless keyboard/mouse 4, the pointer control unit 111 controls a position of a pointer displayed on the screen of the display unit 21 of the TV 2, such as moving the pointer. Additionally, when the PC operation screen is displayed on the display unit 31 of the wireless device 3, the pointer control unit 111 controls a position of a pointer displayed on the screen of the display unit 31 in response to the input from the wireless device 3 or the wireless keyboard/mouse 4. In contrast, when the touch-panel screen is displayed on the display unit 31, the pointer control unit 111 controls so that the pointer does not move on the screen of the display unit 31. Furthermore, when the screen displayed on the display unit 31 is changed from the PC operation screen to the touch-panel screen, the pointer control unit 111 moves the pointer having been displayed on the display unit 31 to the screen of the display unit 21.

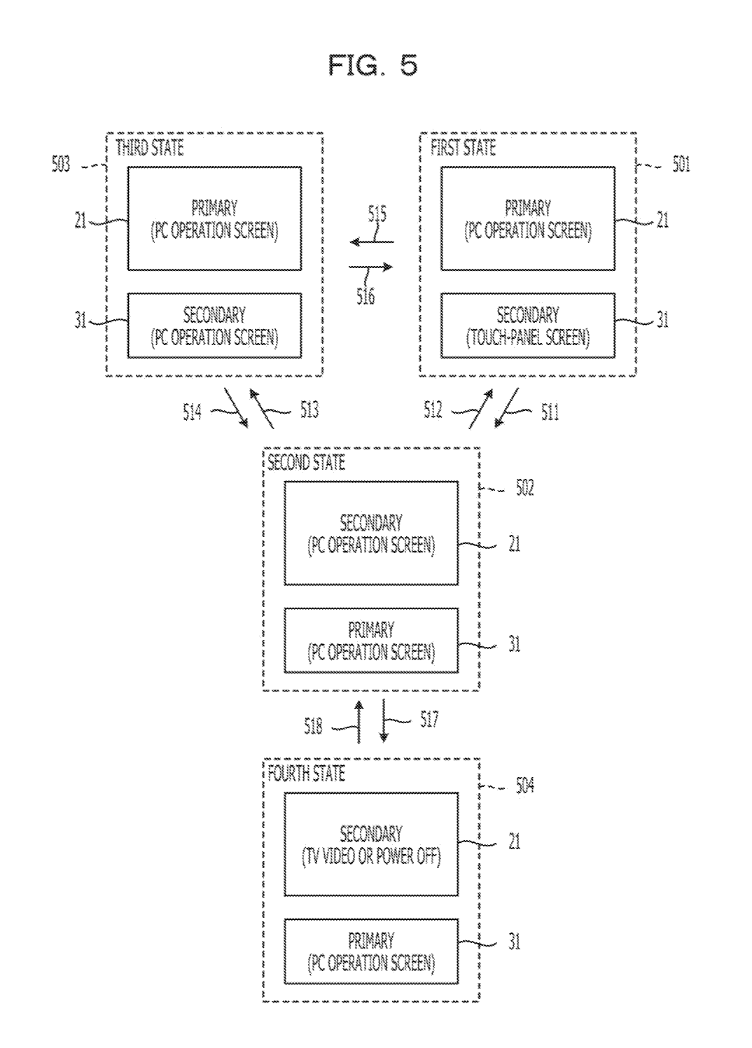

Transition of a screen from each state resulting from screen switching will now be described with reference to FIG. 5. FIG. 5 is a diagram illustrating a transition of the screen resulting from screen switching. Each state of the display screen will be described first.

In a first state 501, the display unit 21 is the primary display serving as a main screen of the PC and the display control unit 11 displays the PC operation screen on the display unit 21. Additionally, the display unit 31 is the secondary display serving as a sub screen of the PC and the display control unit 11 displays a touch-panel screen allowing operators to operate the PC using a touch panel on the display unit 31. In the first state 501, the display control unit 11 causes the display unit 21 and the display unit 31 to display screens independently from each other.

In a second state 502, the display unit 21 is the secondary display and the display control unit 11 displays the PC operation screen on the display unit 21. Additionally, the display unit 31 is the primary screen and the display control unit 11 displays the PC operation screen on the display unit 31. In the second state 502, the display control unit 11 causes the display unit 21 and the display unit 31 to display a screen in cooperation with each other. That is, the display unit 21 and the display unit 31 display one image with two screens thereof. For example, a mouse pointer may be seamlessly moved from the display unit 21 to the display unit 31.

In a third state 503, the display unit 21 is the primary display and the display control unit 11 displays the PC operation screen on the display unit 21. Additionally, the display unit 31 is the secondary display and the display control unit 11 displays the PC operation screen on the display unit 3. Just like the second state 502, in the third state 503, the display control unit 11 causes the display unit 21 and the display unit 31 to display a screen in cooperation with each other. That is, states of the screen on the display unit 21 and the display unit 31 are switched in the second state 502 and the third state 503.

In a fourth state 504, the display unit 21 is the secondary display and the display control unit 11 does not display a screen on the display unit 21 since the TV 2 is displaying a TV video or is turned off. Here, displaying of the TV video on the display unit 21 is performed by the display control unit 23 included in the TV 2 as described later. Additionally, the display unit 31 is the primary display and the display control unit 11 displays the PC operation screen on the display unit 31.

Transition of the screen from each state to another state will now be described.

In response to input of the screen switching instruction in the first state 501, the screen switching unit 112 sets the display unit 31 and the display unit 21 as the primary display and the secondary display, respectively. The screen switching unit 112 also displays the PC operation screen having been displayed on the display unit 21 on the display unit 31. Furthermore, the screen switching unit 112 disables displaying of the touch-panel screen having been displayed on the display unit 31 on the display unit 21. The screen switching unit 112 then displays the PC operation screen on the display unit 21. Here, when displaying of the touch-panel screen having been displayed on the display unit 31 on the display unit 21 is disabled, no image is displayed on the display unit 21 after the operator inputs the screen switching instruction. In this case, the operator is unable to determine whether the display unit 21 has malfunctioned or displaying is disabled. Thus, in this embodiment, the PC operation screen is displayed on the display unit 21 to allow the operator to grasp that no failure has occurred. However, allowing the operator to grasp occurrence of the failure is low, the screen switching unit 112 may simply disable displaying of the touch-panel screen having been displayed on the display unit 31 on the display unit 21. The screen switching unit 112 then stores that the touch-panel screen is displayed on the display unit 31 before the screen switching. In this case, the pointer control unit 111 controls the pointer so that the pointer does not move to the screen of the display unit 31 in the first state 501. In response to input of the screen switching instruction, the pointer control unit 111 controls the pointer so that the pointer moves on the screen of the display unit 31. In this way, the display control unit 11 executes transition 511 of the screen from the first state 501 to the second state 502.

Upon receiving input of the screen switching instruction in the third state 503, the screen switching unit 112 sets the display unit 31 and the display unit 21 as the primary display and the secondary display, respectively. The screen switching unit 112 then displays the PC operation screen having been displayed on the display unit 21 on the display unit 31. Furthermore, the screen switching unit 112 displays the PC operation screen having been displayed on the display unit 31 on the display unit 21. In this case, since the screen having been displayed on the display unit 31 is not the touch-panel screen, displaying the screen as it is does not cause any problem. The screen switching unit 112 then stores information that the PC operation screen is displayed on the display unit 31 before the screen switching. In this way, the screen switching unit 112 executes transition 514 of the screen from the third state 503 to the second state 502.

Conversely, upon receiving the screen switching instruction in the second state 502, the screen switching unit 112 sets the display unit 31 and the display unit 21 as the secondary display and the primary screen, respectively. The screen switching unit 112 determines whether the screen having been displayed on the display unit 21 before the last screen switching stored therein is the touch-panel screen or the PC operation screen.

If the screen having been displayed on the display unit 21 before the last screen switching is the touch-panel screen, the screen switching unit 112 moves an application displayed on the display unit 31 to the display unit 21. The screen switching unit 112 also displays the PC operation screen having been displayed on the display unit 21 on the display unit 31. Furthermore, the screen switching unit 112 displays the touch-panel screen on the display unit 31 using the format of the touch-panel screen stored in the display control unit 11. In this case, the pointer control unit 111 controls the pointer so that the pointer may move on the screen of the display unit 31 in the second state 502. In response to input of the screen switching instruction, the pointer control unit 111 controls the pointer so that the pointer does not move on the screen of the display unit 31. In this way, the display control unit 11 executes transition 512 of the screen from the second state 502 to the first state 501.

In contrast, if the screen having been displayed on the display unit 21 before the last screen switching is the PC operation screen, the screen switching unit 112 displays the PC operation screen having been displayed on the display unit 21 on the display unit 31. Furthermore, the screen switching unit 112 displays the PC operation screen having been displayed on the display unit 31 on the display unit 21. In this way, the display control unit 11 executes transition 513 of the screen from the second state 502 to the third state 503.

A description will now be given for a case in which the display control unit 11 receives an instruction for changing a screen of the display unit 31 to the PC operation screen from the wireless device 3 or the wireless keyboard/mouse 4 in the first state 501. In this case, the display control unit 11 displays on the display unit 31 the PC operation screen that operates in cooperation with the PC operation screen displayed on the display unit 21. In this case, the pointer control unit 111 controls the pointer so that the pointer does not move on the screen of the display unit 31 in the first state 501. In response to the instruction for changing the screen of the display unit 31 to the PC operation screen, the pointer control unit 111 controls the pointer so that the pointer moves on the screen of the display unit 31. In this way, the display control unit 11 executes transition 515 of the screen from the first state 501 to the third state 503.

Conversely, a description will be given for a case in which the display control unit 11 receives an instruction for changing the screen of the display unit 31 to the touch-panel screen from the wireless device 3 or the wireless keyboard/mouse 4 in the third state 503. First, the display control unit 11 moves an application displayed on the display unit 31 to the display unit 21. The display control unit 11 then displays the touch-panel screen on the display unit 31. In this case, the pointer control unit 111 controls the pointer so that the pointer may move on the screen of the display unit 31 in the third state 503. In response to the screen switching instruction, the pointer control unit 111 controls the pointer so that the pointer does not move on the screen of the display unit 31. In this way, the display control unit 11 executes transition 516 of the screen from the third state 503 to the first state 501.

A description will now be give for a case in which the operator operates the TV 2 in the second state 502 to switch the screen displayed on the display unit 21 to the TV video or to turn off the TV 2. When the screen displayed on the display unit 21 is switched to the TV video after the operator operates the TV 2, the display control unit 11 keeps transmitting the PC operation screen to the display unit 21. However, the input of the TV 2 is set to the TV video, the output from the display control unit 11 is not displayed on the display unit 21. Additionally, when the operator turns off the TV 2, the display control unit 11 keeps transmitting the PC operation screen to the display unit 21. However, since the TV 2 is turned off, the output from the display control unit 11 is not displayed on the display unit 21. In this way, transition 517 from the second state 502 to the fourth state 504 is performed in response to the operation of the TV 2 independently from the display control unit 11. Here, in this embodiment, even when the screen of the display unit 21 is switched to the TV video or the TV 2 is turned off, the display control unit 23 keeps transmitting the PC operation screen to the display unit 21 to maintain the operation state of the PC. However, the display control unit 23 may be configured not to transmit the PC operation screen to the display unit 21 to avoid a circumstance where the PC operation screen is hidden by the TV video. In this case, the display control unit 23 preferably moves an application having been displayed on the display unit 21 to the display unit 31.

A description will now be given for a case in which the operator operates the TV 2 in the fourth state 504 to switch the screen displayed on the display unit 21 to the PC operation screen. More specifically, switching of the display screen of the display unit 21 to the PC operation screen indicates changing the input of the TV 2 to the input from the main body 1. In this embodiment, the display control unit 11 keeps transmitting the PC operation screen to the display unit 21 in the fourth state 504. Accordingly, when the input of the TV 2 is changed to the input from the main body 1, the PC operation screen is displayed on the display unit 21. In this way, transition 518 from the fourth state 504 to the second state 502 is executed in response to the operation of the TV 2 independently from the display control unit 11.

The integrated control unit 13 performs various kinds of processing executed in the main body 1, such as execution of a program. For example, the integrated control unit 13 executes processing in response to input from the wireless device 3 or the wireless keyboard/mouse 4. When displaying a screen on the display unit 21 or when the display unit 31 is used during various kinds of processing, the integrated control unit 13 causes the display unit 21 or the display unit 31 to display the screen through the display control unit 11.

The integrated control unit 13 also determines whether a HotPlugDetect signal may be exchanged with the TV 2, i.e., whether the HotPlugDetect signal indicates Connect. If the HotPlugDetect signal does not indicate Connect, the integrated control unit 13 transmits to the screen switching unit 112 information indicating that connection to the TV 2 is disconnected. The integrated control unit 13 also determines whether the TV 2 is connected via a HDMI. If the TV 2 is connected via a HDMI, the integrated control unit 13 determines whether the HDMI-CEC setting is enabled in the TV 2. The integrated control unit 13 then transmits to the screen switching unit 112 information regarding the HDMI-CEC setting of the TV 2. Furthermore, the integrated control unit 13 monitors a command regarding an HDMI-CEC routing, thereby acquiring an input path to the display unit 21 of the TV 2.

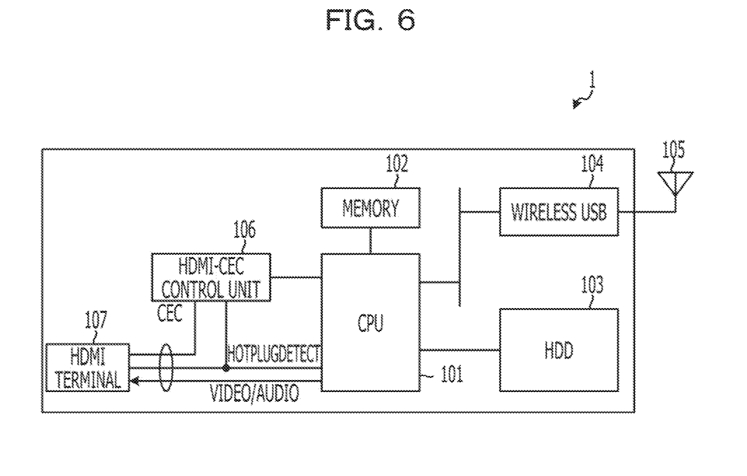

A hardware configuration of the main body 1 will now be described with reference to FIG. 6. FIG. 6 is a diagram of a hardware configuration of the main body 1 according to the first embodiment. As illustrated in FIG. 6, the main body 1 according to the embodiment includes a central processing unit (CPU) 101, a memory 102, a hard disk drive (HDD) 103, a wireless USB 104, an antenna 105, an HDMI-CEC control unit 106, and an HDMI terminal 107. The memory 102 and the HDD 103 serve as a storage unit. The CPU 101 performs various kinds of processing, such as execution of a program, using the memory 102 and the HDD 103. The CPU 101 also transmits and receives data to and from the wireless device 3 and the wireless keyboard/mouse 4 through the wireless USB 104 and the antenna 105. Here, a combination of the CPU 101, the memory 102, and the HDD 103 has a function of the display control unit 11 and the integrated control unit 13 in FIG. 2. Additionally, the wireless USB 104 has a function of the wireless communication control unit 12 in FIG. 2. The HDMI terminal 107 is a connection terminal to HDMI devices. In this embodiment, the TV 2 is connected to the main body 1 through this HDMI terminal 107. The CPU 101 transmits information, such as video and audio, to the TV 2 through the HDMI terminal 107. The HDMI-CEC control unit 106 converts an instruction for controlling the TV 2 output by the CPU 101 into one based on the CEC standard and outputs the converted instruction to the TV 2 through the HDMI terminal 107. The HDMI-CEC control unit 106 also converts a control signal from the TV 2 and outputs the converted control signal to the CPU 101.

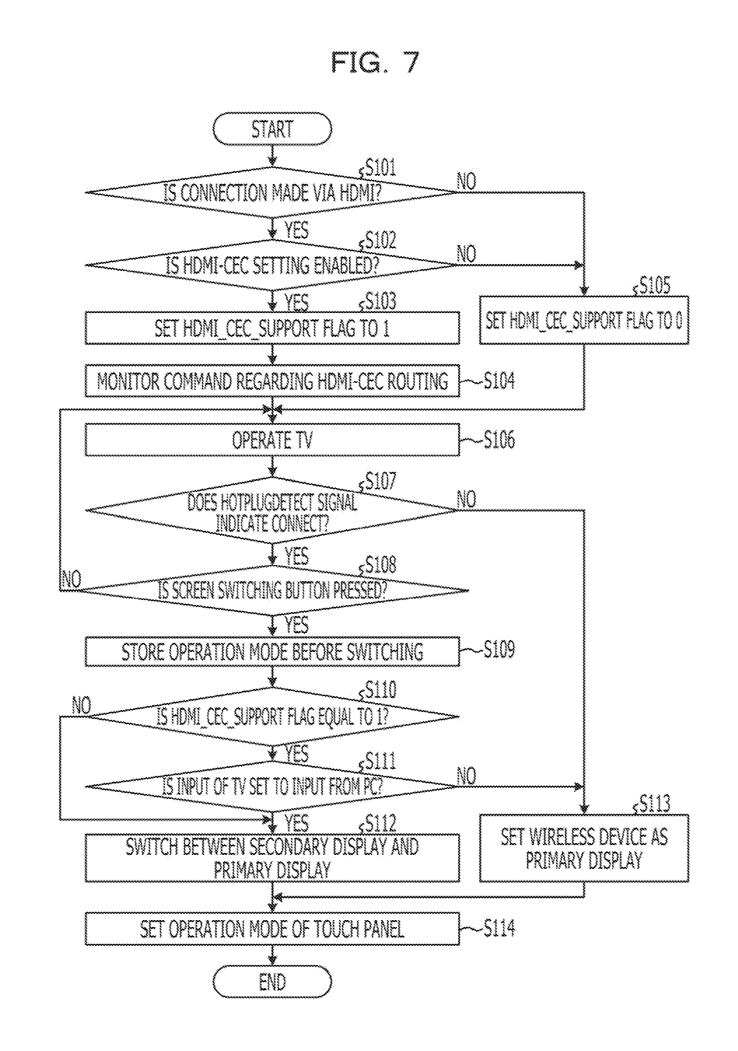

Screen switching processing from the first or third state to the second or fourth state in the information processing apparatus according to the embodiment will now be described with reference to FIG. 7. FIG. 7 is a flowchart of the screen switching processing from the first or third state to the second or fourth state in the information processing apparatus according to the first embodiment.

The integrated control unit 13 determines whether the TV 2 is connected via a HDMI (OPERATION S101).

If the TV 2 is connected via a HDMI (YES in OPERATION S101), the integrated control unit 13 determines whether the HDMI-CEC setting of the TV 2 is enabled (OPERATION S102). If the HDMI-CEC setting is enabled (YES in OPERATION S102), the integrated control unit 13 sets a flag indicating the HDMI-CEC setting, i.e., “HDMI_CEC_SUPPORT Flag”, to 1 (OPERATION S103). The integrated control unit 13 then monitors a common regarding an HDMI-CEC routing (OPERATION S104). In this way, the integrated control unit 13 grasps whether the input of the TV 2 is set to the PC operation screen.

In contrast, if the TV 2 is not connected via a HDMI (NO in OPERATION S101) or if the HDMI-CEC setting of the TV 2 is disabled (NO in OPERATION S102), the integrated control unit 13 sets the HDMI_CEC_SUPPORT Flag to 0 (OPERATION S105).

An operator then operates the TV 2 (OPERATION S106). The operation of the TV 2 indicates, for example, changing a channel and switching of the input.

The integrated control unit 13 determines whether the HotPlugDetect signal indicates Connect (OPERATION S107). Here, the HotPlugDetect signal of Connect indicates that the TV 2 is connected to the main body 1, whereas the HotPlugDetect signal of NotConnect indicates that the TV 2 is disconnected from the main body 1.

If the HotPlugDetect signal does not indicate Connect (NO in OPERATION S107), the screen switching unit 112 sets the display unit 31 of the wireless device 3 as the primary display and displays the PC operation screen thereon (OPERATION S113). At this time, the screen switching unit 112 does not control the display unit 21 of the TV 2.

In contrast, if the HotPlugDetect signal indicates Connect (YES in OPERATION S107), the screen switching unit 112 determines whether the screen switching button is pressed (OPERATION S108). If the screen switching button is not pressed (NO in OPERATION S108), the screen switching unit 112 stands by until the screen switching button is pressed. During this period, OPERATIONs S106 and S107 are repeated. If the screen switching button is pressed (YES in OPERATION S108), the screen switching unit 112 stores a screen having been displayed on the display unit 31, thereby holding an operation mode before the switching (OPERATION S109).

The screen switching unit 112 then determines whether the HDMI_CEC_SUPPORT Flag stored by the integrated control unit 13 is equal to 1 (OPERATION S110). If the HDMI_CEC_SUPPORT Flag is equal to 1 (YES in OPERATION S110), the screen switching unit 112 determines whether the input of the display unit 21 of the TV 2 is set to the PC operation screen (OPERATION S111). If the input of the display unit 21 of the TV 2 is set to the PC operation screen (YES in OPERATION S111), the screen switching unit 112 switches between the primary display and the secondary display (OPERATION S112). The switching between the primary display and the secondary display in OPERATION S112 is described in detail below.

In contrast, if the HDMI_CEC_SUPPORT Flag is not equal to 1 (NO in OPERATION S110), the screen switching unit 112 is unable to receive information on the input of the display unit 21. Accordingly, the screen switching unit 112 switches between the primary display and the secondary display without considering the state of the TV 2 (OPERATION S112). In this case, however, the input of the display unit 21 may not be set to the PC operation screen. In such a case, the PC operation screen is not displayed on the display unit 21.

Additionally, if the input of the display unit 21 is not set to the PC operation screen (NO in OPERATION S111), the screen switching unit 112 sets the display unit 31 of the wireless device 3 to the primary display and displays the PC operation screen thereon (OPERATION S113). At this time, the screen switching unit 112 does not control the display unit 21 of the TV 2.

The pointer control unit 111 then sets an operation mode of the touch panel 35 so that the pointer may move on the touch panel 35 of the display unit 31 (OPERATION S114).

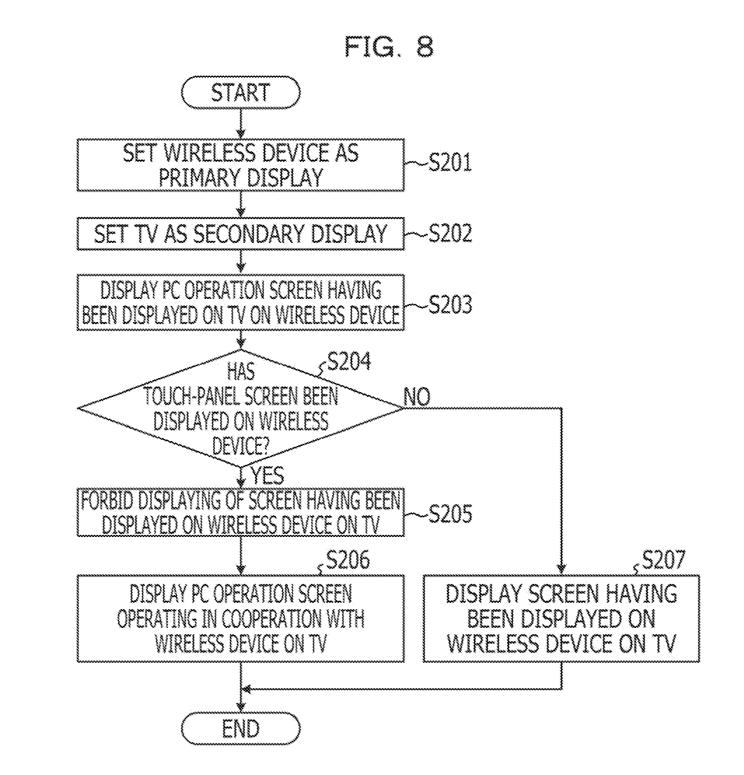

The processing for switching between the primary display and the secondary display in OPERATION S112 of FIG. 7 will now be described in detail with reference to FIG. 8. FIG. 8 is a flowchart of the processing for switching between the primary display and the secondary display.

The screen switching unit 112 sets the display unit 31 of the wireless device 3 as the primary display (OPERATION S201). The screen switching unit 112 also sets the display unit 21 of the TV 2 as the secondary display (OPERATION S202).

Furthermore, the screen switching unit 112 displays the PC operation screen having been displayed on the display unit 21 of the TV 2 on the display unit 31 of the wireless device 3 (OPERATION S203).

The screen switching unit 112 then determines whether the screen having been displayed on the display unit 31 of the wireless device 3 before switching is the touch-panel screen (OPERATION S204).

If the screen having been displayed on the display unit 31 is the touch-panel screen (YES in OPERATION S204), the screen switching unit 112 forbids displaying of the screen having been displayed on the display unit 31 of the wireless device 3 on the display unit 21 of the TV 2 (OPERATION S205). The screen switching unit 112 then displays on the display unit 21 of the TV 2 the PC operation screen that operates in cooperation with the PC operation screen displayed on the display unit 31 of the wireless device 3 (OPERATION S206).

If the screen having been displayed on the display unit 31 is not the touch-panel screen (NO in OPERATION S204), the screen switching unit 112 displays the screen having been displayed on the display unit 31 of the wireless device 3 on the display unit 21 of the TV 2 (OPERATION S207).

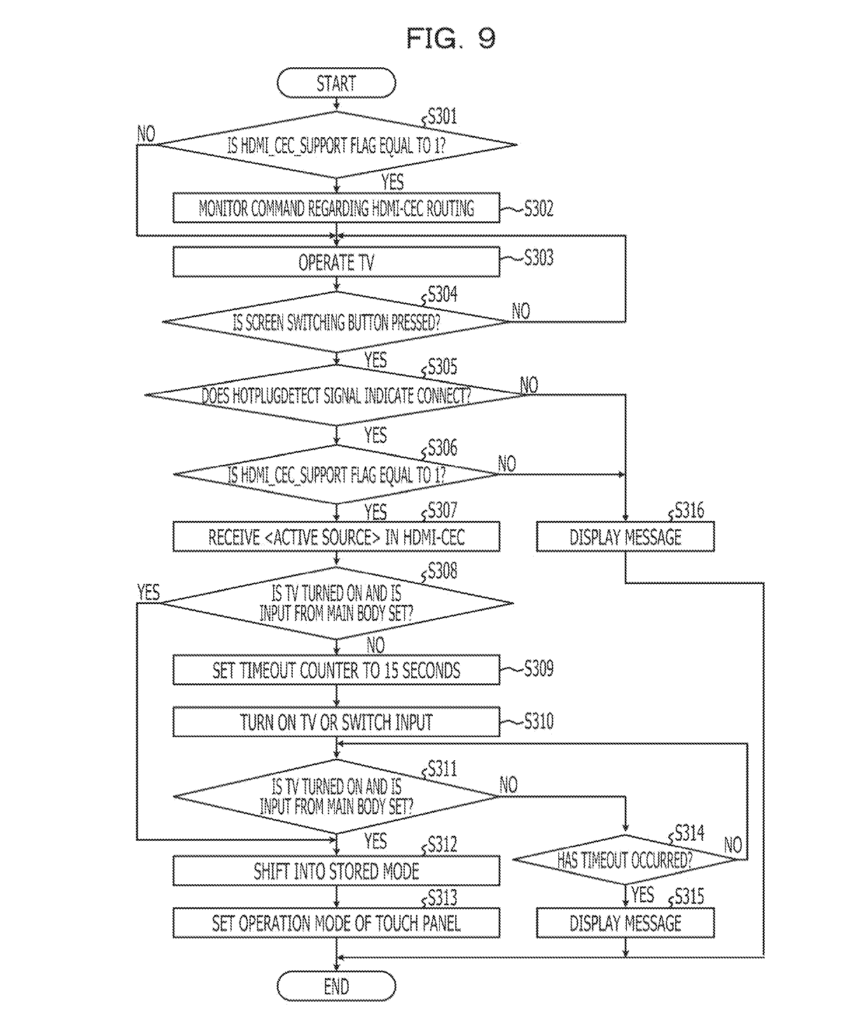

The screen switching processing from the second or fourth state to the first or third state in the information processing apparatus according to the information processing apparatus according to the embodiment will now be described with reference to FIG. 9. FIG. 9 is a flowchart of the screen switching processing from the second or fourth state to the first or third state in the information processing apparatus according to the first embodiment. Here, a description will be given based on an assumption that the processing illustrated in FIG. 9 starts once the states of the display unit 21 and the display unit 31 shift into the second or fourth state because of the processing illustrated in FIG. 7.

The integrated control unit 13 has set the HDMI_CEC_SUPPORT Flag to 1 or 0 in the processing illustrated in FIG. 7. Accordingly, the integrated control unit 13 determines whether the HDMI_CEC_SUPPORT Flag is equal to 1 (OPERATION S301). If the HDMI_CEC_SUPPORT Flag is equal to 1 (YES in OPERATION S301), the integrated control unit 13 monitors a command regarding an HDMI-CEC routing (OPERATION S302). In contrast, if the HDMI_CEC_SUPPORT Flag is not equal to 1 (NO in OPERATION S301), the integrated control unit 13 does not monitor the command regarding the HDMI-CEC routing.

An operator then operates the TV 2 (OPERATION S303).

The screen switching unit 112 determines whether the screen switching button is pressed (OPERATION S304). If the screen switching button is not pressed (NO in OPERATION S304), the screen switching unit 112 stands by until the screen switching button is pressed. During that period, OPERATION S303 is repeated.

If the screen switching button is pressed (YES in OPERATION S304), the integrated control unit 13 determines whether the HotPlugDetect signal indicates Connect (OPERATION S305).

If the HotPlugDetect signal does not indicate Connect (NO in OPERATION S305), the display control unit 11 displays on the display unit 31 a message saying that switching is not permitted and then terminates the display switching processing (OPERATION S316).

In contrast, if the HotPlugDetect signal indicates Connect (YES in OPERATION S305), the screen switching unit 112 determines whether the HDMI_CEC_SUPPORT Flag stored by the integrated control unit 13 is equal to 1 (OPERATION S306). If the HDMI_CEC_SUPPORT Flag is not equal to 1 (NO in OPERATION S306), the display control unit 11 displays a message saying that switching is not permitted on the display unit 31. The display control unit 11 then terminates the screen switching processing (OPERATION S316).

In contrast, if the HDMI_CEC_SUPPORT Flag is equal to 1 (YES in OPERATION S306), the screen switching unit 112 receives an HDMI-CEC command, i.e., “Active Source”, from the TV 2 to acquire information of an apparatus that is currently inputting an image signal to the display unit 21 (OPERATION S307).

The screen switching unit 112 determines whether the TV 2 is turned on and the input of the display unit 21 is set to input from the main body 1 (OPERATION S308). If the TV 2 is turned off or the input is not set to the input from the main body 1 (NO in OPERATION S308), the screen switching unit 112 sets a timeout count value to 15 seconds (OPERATION S309). The screen switching unit 112 turns on the TV 2 if the TV 2 is off. If the input of the display unit 21 is not set to the input from the main body 1, the screen switching unit 112 switches the input of the display unit 21 to the input from the main body 1 (OPERATION S310).

The screen switching unit 112 determines whether the TV 2 is turned on and the input of the display unit 21 is set to the input from the main body 1 (OPERATION S311). If the TV 2 is turned off or the input is not set to the input from the main body 1 (NO in OPERATION S311), the screen switching unit 112 determines whether timeout has occurred (OPERATION S314). If the timeout has not occurred, the screen switching unit 112 stands by until the TV 2 is turned on and the input is set to the input from the main body 1. In contrast, if the timeout has occurred (YES in OPERATION S314), the display control unit 11 displays a message saying that control of the TV 2 has failed on the display unit 31 (OPERATION S315) and terminates the screen switching processing.

In contrast, if it is determined that the TV 2 is turned on and the input is set to the input from the main body 1 (YES in OPERATION S308 or YES in OPERATION S311), the screen switching unit 112 shifts the states of the display unit 21 and the display unit 31 into the stored mode (OPERATION S312). More specifically, the screen switching unit 112 displays on the display unit 31 the screen matching the stored one having been displayed on the display unit 31 before switching. The screen switching unit 112 also displays the PC operation screen on the display unit 21.

The pointer control unit 111 sets the operation mode of the touch panel 35 (OPERATION S313). More specifically, when the touch-panel screen is displayed on the display unit 31, the pointer control unit 11 controls the pointer so that the pointer does not move on the display unit 31. At this time, the display control unit 11 moves an application and the pointer having been displayed on the display unit 31 to the display unit 21. In contrast, when the PC operation screen is displayed on the display unit 31, the pointer control unit 111 controls the pointer so that the pointer may move on the display unit 31.

As described above, since an operator may switch between the primary display and the secondary display simply by pressing the screen switching button, the information processing apparatus according to the embodiment may switch the screen in response to a simple operation. In this way, the operability may be improved. Additionally, after switching, the information processing apparatus may disable displaying of the touch-panel screen having been displayed on the wireless device before switching on the TV. Thus, it is prevented to display the touch panel screen on the TV. In this way, an operation confusion caused by screen switching may be reduced or prevented.

Although the above description has been given based on an assumption that the TV 2 has an HDMI terminal, the information processing apparatus according to the embodiment may operate even if the TV 2 does not have the HDMI terminal. In such a case, simplification of the screen switching and restriction of displaying of the touch-panel screen after switching may be also realized and the improvement in the operability and the prevention of the operation confusion may be advantageously provided.

### Second Embodiment

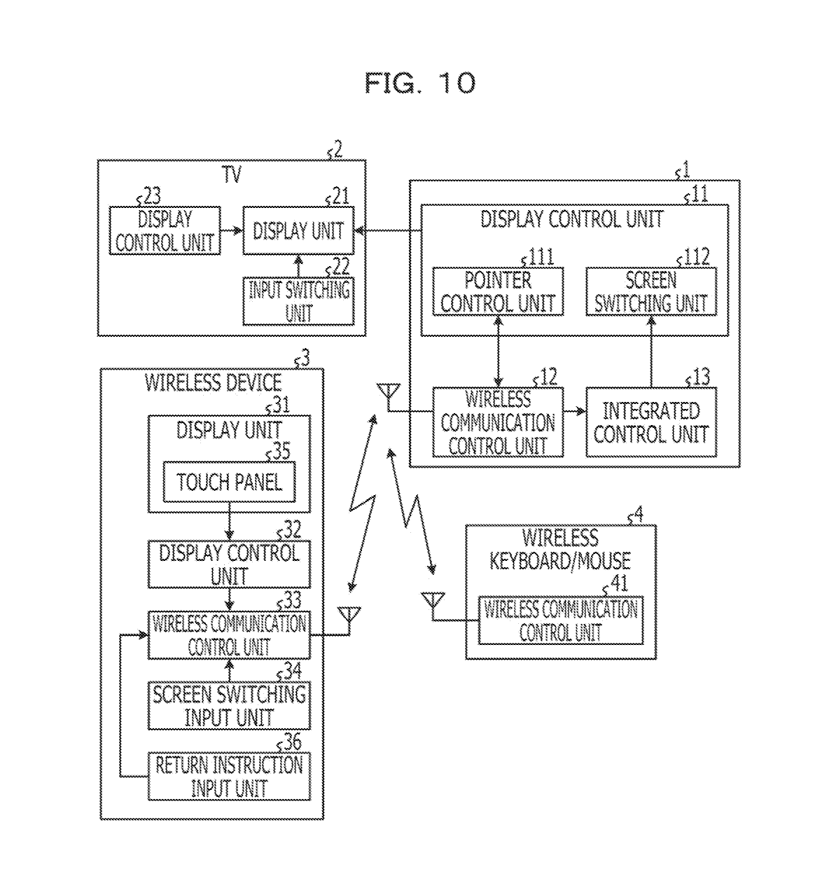

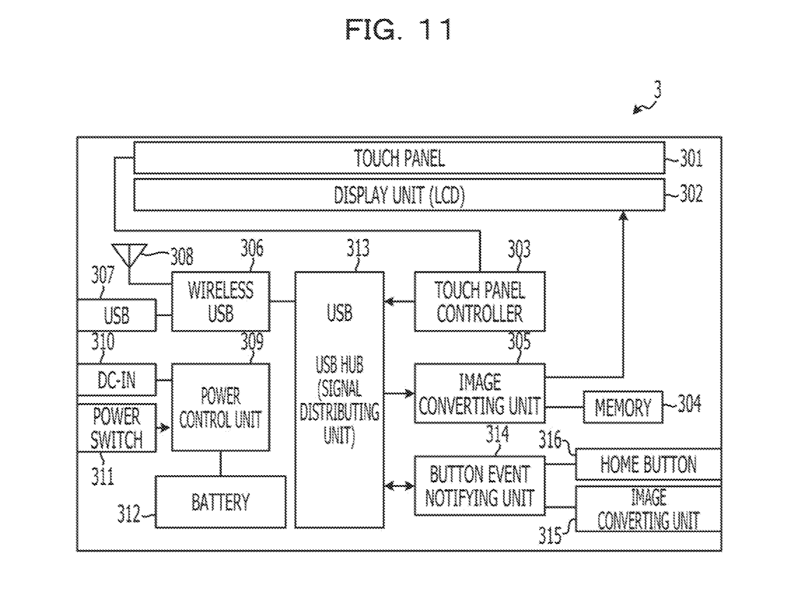

FIG. 10 is a block diagram of a system including an information processing apparatus according to a second embodiment. Additionally, FIG. 11 is a diagram of a hardware configuration of a wireless device according to the second embodiment. The information processing apparatus according to the embodiment differs from that according to the first embodiment in that states of a display unit 21 and a display unit 31 may be easily returned to initial states. More specifically, the information processing apparatus according to the embodiment has a function for easily returning the states of the display unit 21 and the display unit 31 to a first state 501 from any one of second to fourth states illustrated in FIG. 5. Accordingly, returning to the first state from the other state will be described below. It is assumed that each unit in FIG. 10 having the same reference used in FIG. 2 has the substantially similar function unless otherwise noted. Additionally, each unit in FIG. 11 having the same reference used in FIG. 3 has the substantially similar hardware unless otherwise noted. In the description below, the first state 501 in FIG. 1 indicates the initial state. Furthermore, the first state 501, i.e., the initial state, may be referred to as “home”.

A wireless device 3 according to the embodiment includes a return instruction input unit 36 as illustrated in FIG. 10. The return instruction input unit 36 has a button for inputting an instruction for returning to the first state 501 illustrated in FIG. 5. An operator presses a button of the return instruction input unit 36, whereby the instruction for returning to the first state 501 is transmitted to a display control unit 11 and an integrated control unit 13 of the main body 1. Additionally, the wireless device 3 has an additional hardware configuration, i.e., a home button 316. The home button 316 is connected to a button event notifying unit 314. A combination of the home button 316 and the button event notifying unit 314 have a function of the return instruction input unit 36 illustrated in FIG. 10.

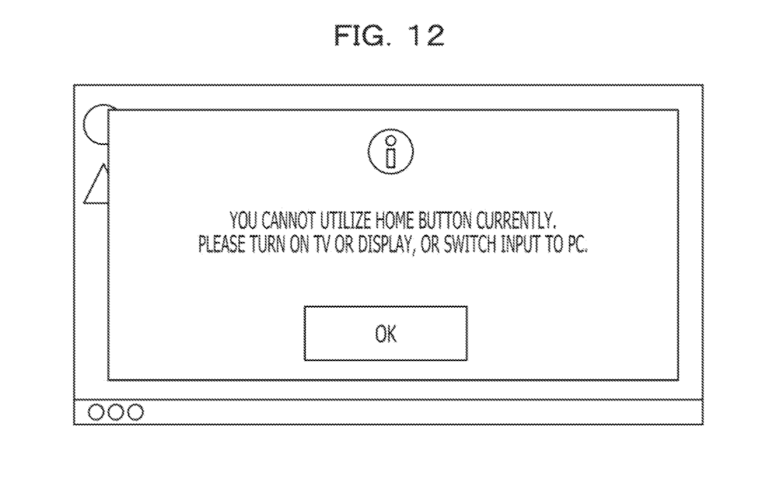

Once the operator inputs the instruction for returning to the first state using the return instruction input unit 36, a screen switching unit 112 determines whether the TV 2 is turned on and input of the display unit 21 is set to input from the main body 1. That is, a screen switching unit 112 according to the embodiment is an example of a determining unit. If the TV 2 is turned off, the screen switching unit 112 turns on the TV 2. That is, the screen switching unit 112 according to this embodiment is an example of a power-on unit. Additionally, when the input of the display unit 21 is not set to the input from the main body 1, the screen switching unit 112 transmits to an input switching unit 22 an instruction for switching the input of the display unit 21 to the input from the main body 1. That is, a combination of the screen switching unit 112 of the main body 1 and the input switching unit 22 of the TV 2 according to the embodiment is an example of an input switching unit. Here, the screen switching unit 112 terminates processing if a specified timeout time has elapsed in the power-on of the TV 2 and the switching of the input of the display unit 21. In this case, the display control unit 11 displays on the display unit 31 a message indicating that the home button may not be utilized. For example, the display unit 31 displays a screen illustrated in FIG. 12. FIG. 12 is a diagram of an example screen displaying the message indicating that the home button may not be utilized.

Once the TV 2 is turned on and the input of the display unit 21 is set to the input from the main body 1, the screen switching unit 112 changes the display unit 21 and the display unit 31 to a primary display and a secondary display, respectively. The screen switching unit 112 then displays a PC operation screen on the display unit 21. The screen switching unit 112 also displays an application activation screen, i.e., a touch-panel screen, on the display unit 31.

In response to input of the instruction for returning to the first state 501, a pointer control unit 111 moves a pointer on the display unit 31 to the display unit 21 if the pointer is displayed on the display unit 31. Furthermore, the pointer control unit 111 controls the pointer so that the pointer does not move on the display unit 31 after the screen switching.

The display control unit 11 determines whether an activated application has been displayed on the display unit 31 before the screen switching. If the activated application has been displayed on the display unit 31 before the screen switching, the display control unit 11 moves the application to the display unit 21.

Furthermore, it is assumed in this embodiment that the display unit 21 of the TV 2 and the display unit 31 of the wireless device 3 have substantially rectangular screens as illustrated in FIG. 1. The display control unit 11 displays a screen so that coordinates on the screen of the display unit 21 and coordinates on the screen of the display unit 31 are continuous. At this time, the display control unit 11 displays the screen so that a long-axis-direction coordinate of the screen of the display unit 31 matches a long-axis-direction coordinate of the screen of the display unit 21. Furthermore, the display control unit 11 displays the screen so that a short-axis-direction coordinate on the screen of the display unit 31 is increased to link the corresponding coordinate on the screen of the display unit 21. Hereinafter, a direction in which the short-axis-direction coordinate increases is referred to as an upper side. More specifically, when the display unit 21 and the display unit 31 are arranged so that the long axis of each of the screens is located in a horizontally extending direction, the coordinates of the display unit 21 are located on the upper side with respect to the coordinates of the display unit 31.

In this way, the display control unit 11 displays the screens so that positions of the coordinates on the screen of the display unit 21 and the coordinates of the screen of the display unit 31 are fixed and continuous, thereby being able to make a continuous screen while maintaining a positional relationship between the screen of the display unit 21 and the screen of the display unit 31. For example, if an operator moves a photo in the upper direction of the display unit 31 with the photo being displayed on the display unit 31 of the wireless device 3, the photo is moved to the display unit 21. The operator may perform this operation regardless of the position of the wireless device 3. That is, even if the operator carries the wireless device 3 horizontally or upside down, the operator moves the photo toward the upper side of the wireless device 3, thereby being able to move the photo onto the screen of the TV 2.

Although the screens are arranged so that the coordinates on the screen of the display unit 21 are located in the direction that the short-axis-direction coordinate on the screen of the display unit 31 increases in this embodiment, other arrangements may be used. For example, the coordinates on the screen of the display unit 21 may be located in a direction that the short-axis-direction coordinate on the screen of the display unit 31 decreases, a direction that the long-axis-direction coordinate on the screen of the display unit 31 increases, or a direction that the long-axis-direction coordinate on the screen of the display unit 31 decreases.

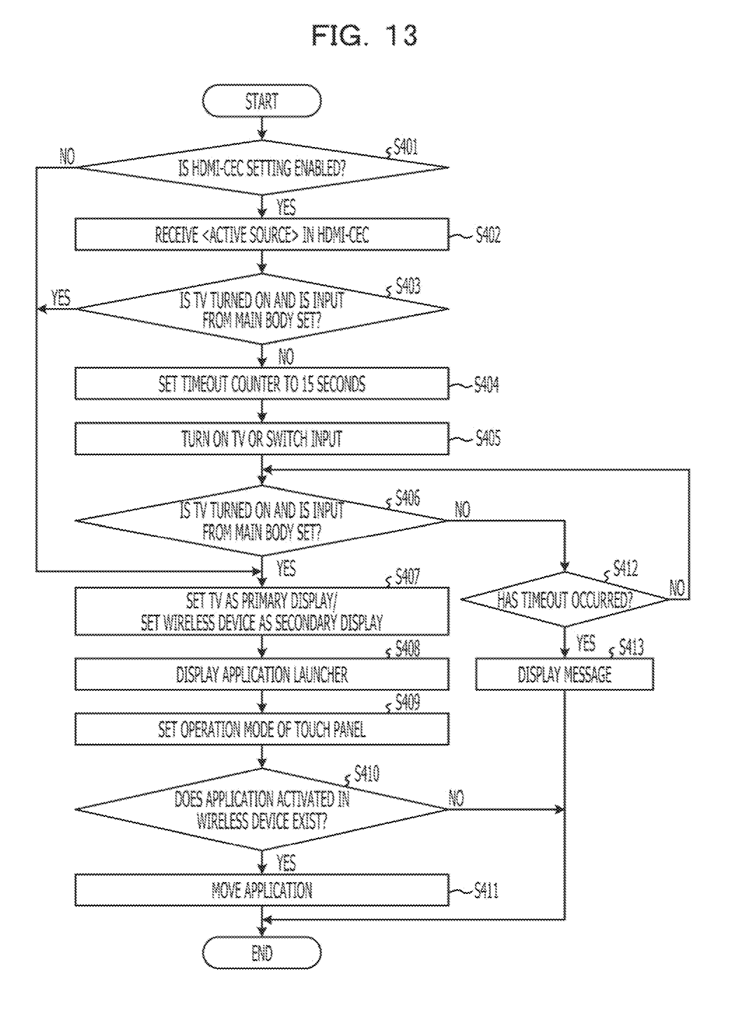

Processing performed in response to pressing of the home button will now be described with reference to FIG. 13. FIG. 13 is a flowchart of the processing performed in response to pressing of the home button.

The integrated control unit 13 determines whether the HDMI-CEC setting is enabled in the TV 2 (OPERATION S401). If the HDMI-CEC setting is enabled (YES in OPERATION S401), the screen switching unit 112 receives an HDMI-CEC command, i.e., Active Source, from the TV 2 to acquire information on an apparatus that is inputting an image signal to the display unit 21 (OPERATION S402).

The screen switching unit 112 determines whether the TV 2 is turned on and the input of the display unit 21 is set to the input from the main body 1 (OPERATION S403).

If the TV 2 is turned off or the input is not set to the input from the main body 1 (NO in OPERATION S403), the screen switching unit 112 sets a timeout count value to 15 seconds (OPERATION S404). If the TV 2 is off, the screen switching unit 112 turns on the TV 2. If the input of the display unit 21 is not set to the input from the main body 1, the screen switching unit 112 switches the input of the display unit 21 to the input from the main body 1 (OPERATION S405).

The screen switching unit 112 determines whether the TV 2 is turned on and the input of the display unit 21 is set to the input from the main body 1 (OPERATION S406). If the TV 2 is turned off or the input is not set to the input from the main body 1 (NO in OPERATION S406), the screen switching unit 112 determines whether timeout has occurred (OPERATION S412). If the timeout has not occurred (NO in OPERATION S412), the screen switching unit 112 stands by until the TV 2 is turned on and the input is set to the input from the main body 1. In contrast, if the timeout has occurred (YES in OPERATION S412), the display control unit 11 displays a message saying that control of the TV 2 has failed on the display unit 31 (OPERATION S413) and terminates the screen switching processing.

In contrast, if it is determined that the TV 2 is turned on and the input is set to the input from the main body 1 (YES in OPERATION S403 or YES in OPERATION S406), the screen switching unit 112 sets the display unit 21 of the TV 2 as the primary display. The screen switching unit 112 also sets the display unit 31 of the wireless device 3 as the secondary display (OPERATION S407).

Additionally, if the HDMI-CEC setting is not enabled (NO in OPERATION S401), the process proceeds to OPERATION S407. In this case, control of the TV 2 is not permitted because the HDMI-CEC setting is disabled. Thus, the screen switching unit 112 switches an image while ignoring the state of the TV 2.

The screen switching unit 112 displays an application launcher, i.e., a touch-panel screen, on the display unit 31 (OPERATION S408).

If a pointer is displayed on the display unit 31, the pointer control unit 111 moves the pointer to the display unit 21 and also controls the pointer so that the pointer does not move to the display unit 31 after the screen switching, thereby setting an operation mode of a touch panel (OPERATION S409).

The display control unit 11 determines whether an activated application exists on the display unit 31 of the wireless device 3 (OPERATION S410). If the activated application exists on the display unit 31 (YES in OPERATION S410), the display control unit 11 moves the application activated on the display unit 31 to the display unit 21 (OPERATION S411).

In contrast, if there is no application activated on the display unit 31 (NO in OPERATION S410), the display control unit 11 terminates the screen switching processing.

As described above, the information processing apparatus according to the second embodiment may shift each of the display units back to the first state, i.e., the initial state, in response to pressing of the home button even if the display units are in any state. In contrast, for example, when a TV is turned off, an operator turns on the TV, changes the input to the input from the information processing apparatus to construct a multi-display environment, and then inputs an instruction for returning to the initial state in the related art. As described above, many operations are taken in the related art to returning to the initial state and processing for returning to the initial state is very troublesome. In contrast, since the states are automatically returned to the initial state simply by pressing the home button in the information processing apparatus according to the second embodiment, the state may be easily returned to the initial state and the operability advantageously improves.

Although the description has been given in each of the above embodiments for the configuration for displaying a screen on the display unit 31 via wireless connection, the display unit 31 may be connected to the main body 1 with a cable. In such a case, simplification of a procedure of the screen switching and restriction of displaying of an unnecessary screen resulting from the screen switching may be also realized and an improvement in the operability and prevention of the operation confusion may be advantageously provided.

Although the embodiments have been described mainly for an information processing apparatus and a method of controlling the information processing apparatus, functions substantially similar to the above-described embodiments may be realized by executing a previously prepared information processing program with a computer. Additionally, the program for controlling the information processing apparatus may be recorded on a memory, a hard disk, and other computer-readable recording media provided to the computer and may be read and executed from the recording media by the computer.

More specifically, in the embodiments, the program for controlling the information processing apparatus demonstrating the functions for executing the above-described various kinds of processing is stored in the HDD 103 of the main body 1. The CPU 101 reads and executes the program for controlling the information processing apparatus from the HDD 103. In this way, the program for controlling the information processing apparatus functions as a process for controlling the information processing apparatus that executes the above-described various kinds of processing.

Additionally, although a TV is used as an example in the description of each of the above-described embodiments, the information processing apparatus may be applied to other display devices as long as the display devices have the HDMI terminal. Furthermore, although the above description has been given based on an assumption that the TV has the HDMI terminal, the information processing apparatus may operate if an input source of a video signal to display devices may be grasped, i.e., display devices having a specification equivalent to a HDMI.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiment(s) of the present invention(s) has(have) been described in detail, it should be understood that the various changes, substitutions, and alterations could be made hereto without departing from the spirit and scope of the invention.

What is claimed is:

1. An information processing apparatus, comprising:
a screen switching input unit to input a switching instruction to switch between a screen displayed on a first display unit and a screen displayed on a second display unit; and
a display control unit to display, in response to the switching instruction, the screen displayed on the first display unit on the second display unit and disabling displaying of the screen displayed on the second display unit before input of the switching instruction on the first display unit.

2. The information processing apparatus according to claim 1, wherein the first display unit is a television.

3. The information processing apparatus according to claim 1, wherein the second display unit is wirelessly connected to the display control unit.

4. The information processing apparatus according to claim 1, wherein the second display unit includes a touch panel.

5. The information processing apparatus according to claim 1, wherein the screen switching input unit is wirelessly connected to the display control unit, and wherein the second display unit and the screen switching input unit are arranged in a casing.

6. The information processing apparatus according to claim 1, wherein the display control unit comprising:
a pointer control unit to disable movement of a pointer on the second display unit in a case where a screen to receive an operation performed with a touch panel is displayed on the second display unit.

7. The information processing apparatus according to claim 6, wherein the pointer control unit enables the movement of the pointer on the second display unit upon receiving the screen switching instruction with the screen to receive the operation performed with the touch panel being displayed on the second display unit.

8. The information processing apparatus according to claim 1, further comprising:
a return instruction input unit to display an operation screen of the information processing apparatus on the first display unit when the first display unit serves as a main screen and the second display unit serves as a sub screen and to input a return instruction to return to an initial state in which a specified screen is displayed on the second display unit;
a determining unit to determine, in response to the return instruction, whether the first display unit is turned on and whether input of the first display unit is set to input from the information processing apparatus;
a power-on unit to turn on the first display unit when the determining unit determines that the first display unit is turned off; and
an input change unit to change the input of the first display unit to the input from the information processing apparatus when it is determined that the input of the first display unit is not set to the input from the information processing apparatus, wherein
the display control unit returns, when the determining unit determines that the first display unit is turned on and the input of the first display unit is set to the input from the information processing apparatus or when at least one of the power-on unit and the input change unit creates a state where the first display unit is turned on and the input of the first display unit is set to the input from the information processing apparatus, the screens to the initial state by displaying the operation screen of the information processing apparatus on the first display unit serving as the main screen and displaying the specified screen on the second display unit serving as the sub display.

9. The information processing apparatus according to claim 7, wherein the display control unit moves, when the screen to receive the operation performed with the touch panel is displayed on the second display unit as the specified screen in response to input of the return instruction, an activated application displayed on the second display unit at the time of reception of input of the return instruction to the first display unit.

10. The information processing apparatus according to claim 8, wherein each of the first display unit and the second display unit has a substantially rectangular screen, and wherein the display control unit displays the screen so that a coordinate on the screen of the first display unit and a coordinate on the screen of the second display unit are continuous and a short-axis-direction coordinate on the screen of the first display unit is larger than a short-axis-direction coordinate on the screen of the second display unit.

11. The information processing apparatus according to claim 10, wherein the display control unit displays the screen in the initial state so that a center of a long-axis-direction coordinate of the first display unit matches a center of the short-axis-direction of the coordinate of the second display unit.

12. The information processing apparatus according to claim 8, wherein the return instruction input unit is wirelessly connected to the display control unit, and wherein the second display unit and the return instruction input unit are arranged in a casing.

13. A method of controlling an information processing apparatus, the method comprising:
receiving input of a switching instruction to switch between a screen displayed on a first display and a screen displayed on a second display;
displaying the screen displayed on the first display on the second display; and
disabling displaying of the screen displayed on the second display before input of the switching instruction on the first display.

14. The method of controlling the information processing apparatus according to claim 13, the method further comprising:
disabling, when a screen to receive an operation with a touch panel is displayed on the second display, movement of a pointer on the second display.

15. The method of controlling the information processing apparatus according to claim 14, wherein movement of the pointer on the second display is enabled in response to the switching instruction with the movement of the pointer on the second display being disabled and the screen to receive the operation performed with the touch panel being displayed on the second display.

16. A computer-readable recording medium recording a control program executed by an information processing apparatus, the control program causing the information processing apparatus to execute a method, the method comprising:
receiving input of a switching instruction to switch between a screen displayed on a first display and a screen displayed on a second display;
displaying the screen displayed on the first display on the second display; and
disabling displaying of the screen displayed on the second display before input of the switching instruction on the first display.

17. The recording medium according to claim 16, the method further comprising:
disabling, when a screen to receive an operation with a touch panel is displayed on the second display, movement of a pointer on the second display.

18. The recording medium according to claim 17, wherein movement of the pointer on the second display is enabled in response to the switching instruction with the movement of the pointer on the second display being disabled and the screen to receive the operation performed with the touch panel being displayed on the second display.
